(19) United States
(12) Patent Application Publication
(10) Pub. No.: US 2005/0172670 A1
(43) Pub. Date: Aug. 11, 2005

(54) Method of manufacturing a glass substrate for a magnetic disk and method of manufacturing a magnetic disk

(75) Inventor: Naohiro Kamiya, Tokyo (JP)

Correspondence Address: SUGHRUE MION, PLLC, 2100 Pennsylvania avenue, NW, Washington, DC, 20037-3213, US

(73) Assignee: HOYA CORPORATION

(21) Appl. No.: 10/773,431

(22) Filed: Feb. 9, 2004

(30) Foreign Application Priority Data
Feb. 7, 2004 (JP) 31630/2003

(51) Int. Cl. C03C 21/00

(52) U.S. Cl. 65/30.14; 65/31; 65/61

(57) ABSTRACT

A principal surface of a glass disk is mirror-polished. Then, the glass disk is subjected to a chemical treatment so as to remove a polishing-affected layer on the principal surface of the mirror-polished glass disk. Thereafter, a texture is formed on the principal surface of the glass disk by a tape. Thus, a glass substrate for a magnetic disk is obtained.

This application claims priority to prior Japanese application JP 2003-31630, the disclosure of which is incorporated herein by reference.

### BACKGROUND OF THE INVENTION

This invention relates to a method of manufacturing a magnetic disk to be mounted in a magnetic disk apparatus such as a HDD (hard disk drive) and a method of manufacturing a glass substrate for the magnetic disk.

At present, following the rapid development of the IT industry, dramatic technical innovation is required in the information recording technology, particularly, in the magnetic recording technology. In a magnetic disk mounted to a HDD or the like, a technique capable of achieving an information recording density of 40 Gbit/inch² to 100 Gbit/inch² or higher is required in response to the demand for a higher recording capacity.

The magnetic disk is required to be excellent in magnetic characteristics particularly in a flying/tracking direction of a magnetic recording head. In view of the above, it is proposed, for example, in Japanese Unexamined Patent Publication No. S62-273619 that, after a texture for inducing magnetic anisotropy is formed on a surface of a metal substrate, such as an aluminum alloy or the like, a magnetic layer is deposited so as to improve magnetic characteristics in the flying/tracking direction of the magnetic recording head, as compared with magnetic characteristics in a radial direction.

Following the recent demand for mobile use and miniaturization of the HDD, attention is directed to a glass substrate high in rigidity, excellent in shock resistance, and high in surface smoothness.

Since the glass substrate is excellent in shock resistance, it is unnecessary to enhance the rigidity by coating the substrate with a metal film such as a NiP as required in the aluminum alloy substrate. As a consequence, a production process can be shortened. Therefore, it is possible to provide a magnetic disk low in cost. In addition, miniaturization is easy.

For example, Japanese Unexamined Patent Publication No. 2002-32909 (hereinafter, will be referred to as a first conventional technique) proposes a magnetic recording medium comprising a glass substrate provided with a circumferential texture formed thereon, and a magnetic layer formed on the substrate by sputtering.

In case of the glass substrate also, it is desired that magnetic characteristics in a circumferential direction are excellent as compared with magnetic characteristics in a radial direction. For example, in order to achieve a recording density of 40 Gbit/inch² or more, an oriented ratio of magnetic anisotropy (MrtOR) in terms of a product of residual magnetization and film thickness must be equal to 1.2 or more. In order to achieve a recording density of 50 Gbit/inch² or more, MrtOR must be equal to 1.3 or more. In particular, in a higher recording density region of 60 Gbit/inch² or more, MrtOR is desirably equal to 1.35 or more.

The above-mentioned MrtOR represents the oriented ratio OR of magnetic anisotropy calculated from the product (Mrt) of residual magnetization and film thickness. At any given point on a principal surface of the magnetic recording medium, the product of residual magnetization and film thickness in the circumferential direction is represented by Mrt(c) while the product of magnetization and film thickness in the radial direction is represented by Mrt(r). In this event, MrtOR is defined as Mrt(c)/Mrt(r) as a ratio of Mrt(c) with respect to Mrt(r). Herein, Mrt is a product of Mr (residual magnetization) and t (thickness of the magnetic layer of the medium).

Specifically, if MrtOR is substantially equal to 1, the magnetic recording medium has a magnetic isotropy such that the magnetic characteristic in the circumferential direction is substantially same as that in the radial direction. As MrtOR becomes greater beyond 1, the magnetic anisotropy in the circumferential direction is improved.

However, different from the case where the texture for inducing the magnetic anisotropy is formed on a metallic surface such as the aluminum alloy substrate or a substrate coated with a metal film such as NiP, in case where the texture for inducing the magnetic anisotropy is directly formed on a surface of the glass substrate and the magnetic layer is formed thereon as proposed in the aforementioned first conventional technique, MrtOR is no more than 1.0 to 1.1. This constitutes a factor of inhibiting an increase in capacity and a decrease in production cost of the HDD.

### SUMMARY OF THE INVENTION

It is therefore an object of this invention to provide a glass substrate for a magnetic disk which is capable of obtaining MrtOR of 1.2 or more so as to achieve a recording density of 40 Gbit/inch² or more even if a glass substrate is used and which is excellent in shock resistance and low in production cost.

It is another object of this invention to provide a magnetic disk which is capable of obtaining MrtOR of 1.2 or more so as to achieve a recording density of 40 Gbit/inch² or more even if a glass substrate is used and which is excellent in shock resistance and low in production cost.

The present inventor has enthusiastically studied with respect to the above-mentioned objects and, as a result, the following facts have been found out. In order to manufacture a glass substrate for a magnetic disk, a principal surface of a glass disk is mirror-polished. Then, before a texture for inducing magnetic anisotropy in the magnetic layer is formed on the principal surface, the glass disk is subjected to a chemical treatment with a chemical liquid. Thereafter, the principal surface is subjected to a texturing process. In the above-mentioned manner, a desired uniform texture shape can be suitably formed. As a result, when a magnetic layer is formed on the glass substrate obtained after forming the texture, high magnetic anisotropy can be obtained.

In order to achieve the aforementioned objects, this invention has the following aspects.

(First Aspect)

A method of manufacturing a glass substrate for a magnetic disk, in which a texture is formed by a tape on a principal surface of a mirror-polished glass disk, wherein the glass substrate is subjected to a chemical treatment before forming the texture so as to remove at least a part of a polishing-affected or damaged layer which is formed on the principal surface of the glass disk.

(Second Aspect)

A method of manufacturing a glass substrate for a magnetic disk according to the above-mentioned first aspect, wherein the chemical treatment is carried out by the use of at least one material selected from sodium hydroxide, potassium hydroxide, and ammonium fluoride.

(Third Aspect)

A method of manufacturing a glass substrate for a magnetic disk according to the above-mentioned first aspect, wherein the mirror-polished glass disk is chemically strengthened after mirror-polishing.

(Fourth Aspect)

A method of manufacturing a glass substrate for a magnetic disk according to the above-mentioned first aspect, wherein the glass disk essentially consists of 58-75 weight % SiO₂, 5-23 weight % Al₂O₃, 3-10 weight % Li₂O, 4-13 weight % Na₂O.

(Fifth Aspect)

A method of manufacturing a glass disk, wherein at least a magnetic layer is formed on the glass substrate manufactured by the method according to the above-mentioned first aspect.

Typically, in case where a glass substrate for a magnetic disk is manufactured, a glass disk (a glass formed in a disk-like shape) is subjected to a rough lapping step (rough grinding step), a shaping step, and a fine lapping step (fine grinding step) and is thereafter subjected to a step of mirror-polishing a principal surface thereof before a texturing step.

The mirror-polishing step is generally carried out in the following manner. Specifically, polishing is performed by a so-called batch-type double-sided polishing method in which a large number of glass disks are placed on a polishing carrier and the polishing carrier is made to execute a planetary gear operation by the use of a sun gear and an internal gear to thereby perform the polishing. In the above-mentioned batch-type double-sided polishing method, a polishing pad polisher is attached to each of upper and lower surface tables of a polishing apparatus. The polishing is carried out by using the polishing pad polisher and free abrasive grains (cerium oxide abrasive grains or the like) having a grain size within a range of about 0.3-3.0 μm so that the principal surface of the glass disk has a mirror surface. In this manner, the polishing is carried out so that the glass disk has a mirror surface, for example, having a surface roughness Rmax of 5 nm or less.

In the above-mentioned mirror-polishing step, the glass disk is polished under a pressing force caused by a heavy load. Therefore, a polishing-affected layer is formed on a polishing surface of the glass disk. The polishing-affected layer is, for example, a residual stress layer (a polishing stress layer) formed on the polishing surface of the glass disk by the polishing.

According to the present inventor's study, consideration will be made as follows. Specifically, in view of a structure analysis, upon formation of the residual stress layer a structural change is caused to occur in a Si—O network of the principal surface of the glass disk. This structural change results in unevenness in residual stress distribution by the mirror-polishing. Depending upon the trajectory of polishing abrasive grains, a portion having a relatively high residual stress and another portion having a relatively low residual stress are formed on the principal surface of the glass disk.

Accordingly, it is understood that, if the aforementioned texturing is carried out after the mirror-polishing step, a desired uniform texture shape is difficult to obtain because the easiness of texturing is different between the portion having the relatively high residual stress and another portion having the relatively low residual stress. Specifically, in the portion having the relatively high residual stress, texturing is relatively difficult. In another portion having the relatively low residual stress, texturing is relatively easy. It is understood that, from the above-mentioned reason, the unevenness in texture shape occurs on the principal surface of the glass substrate after the texturing step.

In this invention, after the above-mentioned mirror-polishing step, a chemical treatment using a chemical liquid is carried out so as to remove at least a part of the polishing-affected layer on the principal surface of the glass disk, which layer is formed in the polishing step. According to the present inventor's consideration, it is assumed that a surface layer on the principal surface of the glass disk, which exhibits variation in residual stress, is removed. As a result, the variation in residual stress on the principal surface of the glass disk before the texturing step can be suppressed and the surface having a substantially uniform stress is obtained. Therefore, by performing the texturing step, it is possible to obtain a desired uniform texture shape.

In this invention, as the chemical liquid used in the above-mentioned chemical treatment, use is preferably made of an alkali solution containing alkali, such as sodium hydroxide (NaOH) and potassium hydroxide (KOH), or an acid solution containing acid, such as ammonium fluoride (NH₄F). Since such chemical liquid is superior in etchability for glass, it is possible to advantageously remove the polishing-affected layer on the principal surface of the glass disk. Further, the chemical liquid can uniformly etch the principal surface of the glass disk so that the principal surface of the glass disk after the chemical treatment can be finished into the mirror surface. It is noted here that the above-mentioned alkalis, such as NaOH and KOH, may be used alone or as a mixture.

In this invention, the thickness of the polishing-affected layer on the principal surface of the glass disk, which is to be removed in the chemical treatment step before the texturing step, preferably falls within a range of about 0.1-10 nm. If the thickness of the removed polishing-affected layer on the principal surface of the glass disk is too small, the variation of the residual stress on the principal surface of the glass disk after mirror-polishing is undesirably left. On the other hand, if the thickness of the removed polishing-affected layer on the principal surface of the glass disk is too large, a recess defect may undesirably occur on the principal surface of the glass disk.

In this invention, PH of the chemical liquid used in the chemical treatment preferably falls within a range of 8-13 in case of an alkaline chemical liquid. If the PH falls within the above-mentioned range in case of the alkaline chemical liquid, at least a part of the polishing-affected layer on the principal surface of the glass disk is removed so that the variation of the residual stress after mirror-polishing can be sufficiently suppressed. PH exceeding 13 is undesirable because a damage due to the chemical liquid becomes large so that the recess defect tends to occur on the principal surface of the glass disk.

On the other hand, PH preferably falls within a range of 2-5 in case of an acidic chemical liquid. If the acidic chemical liquid having PH within the above-mentioned range is used, at least a part of the polishing-affected layer on the principal surface of the glass disk is removed so that the variation of the residual stress after mirror-polishing can be sufficiently suppressed and the damage due to the chemical liquid does not occur.

The temperature of the chemical liquid used in the chemical treatment is not particularly restricted but preferably falls with a range of about 20° C.-100° C. so that the damage due to the chemical liquid does not occur.

The chemical treatment in this invention is carried out, for example, by dipping the glass disk into the above-mentioned chemical liquid. If appropriate, a supersonic or ultrasonic wave may be applied. In this event, application of the supersonic wave is preferable because a contaminant on the glass disk can be removed so as to improve cleanness of the principal surface of the glass disk. A treatment time period is appropriately determined depending upon the thickness of the removed polishing-affected layer on the principal surface of the above-mentioned glass disk, and so on. Generally, the time period of about 1-10 minutes is appropriate.

As a material of the glass used for manufacturing the glass substrate in this invention, for example, an aluminosilicate glass is preferable. The aluminosilicate glass is adapted to chemical strengthening and high in rigidity and is therefore suitable for achieving a high recording density.

As the aluminosilicate glass, a glass containing an alkali metal element is preferable. A glass substrate containing the alkali metal element is adapted to the chemical strengthening and superior in LUL (load unload) characteristic and shock resistance. Among such aluminosilicate glasses, in particular, use is preferably made of a glass essentially consisting of 58-75 weight % SiO₂, 5-23 weight % Al₂O₃, 3-10 weight % Li₂O, and 4-13 weight % Na₂O.

Further, the aluminosilicate glass preferably has a glass composition essentially consisting of 62-75 wt % SiO₂, 5-15 wt% Al₂O₃, 4-10 wt % Li₂O, 4-12 wt % Na₂O, and 5.5-15 wt % ZrO₂ with Na₂O/ZrO₂ of 0.5-2.0 in weight ratio and Al₂O₃/ZrO₂ of 0.4-2.5 in weight ratio. In order to prevent a protrusion from being formed on the surface of the glass substrate because of presence of an undissolved portion of ZrO₂, use is preferably made of a chemically strengthened glass essentially consisting of 57-74 % SiO₂, 0-2.8 % ZrO₂, 3-15% Al₂O₃, 7-16% Li₂O, and 4-14% Na₂O in mol %.

By chemically strengthening the above-mentioned aluminosilicate glass, the glass is improved in transverse strength, is deep in depth of a compression stress layer, and is excellent in Knoop hardness.

According to the present inventor's study, consideration will be made as follows. Specifically, the aluminosilicate glass is suitable for the high recording density of the magnetic disk, as describe above. On the other hand, upon the mirror-polishing, the structural change occurs in the Si—O network of the principal surface of the glass disk. By this structural change, unevenness occurs in residual stress distribution by the mirror-polishing. Depending upon the trajectory of polishing abrasive grains, a portion having a relatively high residual stress and another portion having a relatively low residual stress tend to be formed on the principal surface of the glass disk.

In this invention, it is assumed that, by carrying out the chemical treatment step before the texturing step so as to remove the polishing-affected layer on the principal surface of the glass disk, the variation of the residual stress on the principal surface of the glass disk can be suppressed, as described above. Thus, this invention is particularly suitable for the substrate using the aluminosilicate glass, and can contribute to the high recording density of the magnetic disk.

As a typical example of the above-mentioned aluminosilicate glass, N5 (product name) manufactured by HOYA CORPORATION is known.

In this invention, it is preferable that the glass disk for manufacturing the glass substrate is a chemically strengthened glass disk. Since the chemically strengthened glass disk has a stress layer which is uniformly formed on the surface of the glass disk, the glass disk is high in strength and flatness. Therefore, the glass disk is excellent in LUL characteristic and shock resistance, and is particularly suitable for a mobile HDD. In the chemically strengthening step, chemical strengthening salt is firmly adhered to the surface of the glass disk so that the shape of the principal surface of the glass disk may be disturbed. Therefore, if the chemically strengthening step is carried out after forming the aforementioned texture on the glass disk, the texture shape for inducing the magnetic anisotropy in the magnetic layer is disturbed by chemical strengthening. As a result, it is sometimes impossible to obtain a desired MrtOR. Accordingly, the chemically strengthening step is preferably carried out prior to the step of forming the aforementioned texture.

In the above-mentioned viewpoint, if the chemically strengthening step is carried out in this invention, it is preferable to perform the mirror-polishing step, the chemically strengthening step, the chemical treatment step, and the texturing step in this order.

The diameter of the glass substrate for a magnetic disk is not particularly restricted. Practically, however, for a small-sized magnetic disk having a diameter of 2.5 inches or less, which is often used as a mobile HDD, this invention is very useful. This is because it is possible in this invention to provide the magnetic disk having high shock resistance and an information recording density of 40 Gbit/inch² or higher and low in cost.

Preferably, the glass substrate has a thickness between about 0.1 mm and 1.5 mm. In particular, for a magnetic disk comprising a thin substrate having a thickness between about 0.1 mm and 0.9 mm, this invention is very useful because the magnetic disk having high shock resistance and low in cost can be provided.

By forming at least a magnetic layer on the glass substrate for a magnetic disk obtained according to this invention, the magnetic disk of this invention is obtained. In this invention, in case where the magnetic disk is obtained by carrying out deposition of films on the glass substrate provided with the texture, it is particularly preferable that the magnetic disk comprises a seed layer, an underlayer, an onset layer, a magnetic layer, a protection layer, a lubrication layer, and the like.

In this invention, the composition of the magnetic layer is not specifically limited. However, a material comprising a Co-based alloy having a hcp crystal structure is preferable because the crystal magnetic anisotropy is high. Among various Co-based alloys, a CoPt based alloy is preferable because high coercive force of 3000 oersted or more can be obtained. Further, a CoCr-based alloy is preferable because exchange interaction between the magnetic grains can be suppressed by Cr so that the medium noise can be reduced. Besides the CoPt alloy and the CoCr alloy, a CoCrPt based alloy, a CoCrPtTa-based alloy, a CoCrPtTaB-based alloy, a CoCrPtB-based alloy, a CoCrPtNb-based alloy or the like may be used as the Co-based alloy. Among others, particularly, the CoCrPtB alloy is low in medium noise and is therefore advantageous in order to achieve a high recording density. In case of the CoCrPtB alloy, a preferable composition is 13-25 at % Cr, 6-15 at % Pt, 2-10 at % B, and the balance Co.

As the seed layer, for example, use is made of an alloy having a bcc or B2 crystal structure, such as an Al-based alloy, a Cr-based alloy, an NiAl-based alloy, an NiAlB-based alloy, an AlRu-based alloy, an AlRuB-based alloy, an AlCo-based alloy, and an FeAl-based alloy. By the use of the above-mentioned alloy, the magnetic grains can be miniaturized.

As the underlayer, use may be made of a Cr-based alloy, a CrMo-based alloy, a CrV-based alloy, a CrW-based alloy, a CrTi-based alloy, or a Ti-based alloy to serve as a layer for adjusting the orientation of the magnetic layer.

As the onset layer, use is made of a nonmagnetic material having a crystal structure similar to that of the magnetic layer so as to help epitaxial growth of the magnetic layer. For example, if the magnetic layer is made of a Co-based alloy material, use is made of a nonmagnetic material having a hcp crystal structure, for example, a CoCr-based alloy, a CoCrPt-based alloy, and a CoCrPtTa-based alloy.

As the protection layer, for example, a carbon protection film may be used.

On the protection layer, a lubrication layer may be formed. As a lubricant forming the lubrication layer, a PFPE (perfluoropolyether) compound is preferable.

In this invention, deposition of each layer onto the glass substrate for a magnetic disk may be carried out by the use of various known techniques. Among others, sputtering is advantageous because each layer can be reduced in thickness.

In this invention, the texture for inducing the magnetic anisotropy in the magnetic layer is required to have a regular shape such that the magnetic anisotropy for the magnetic layer in the flying/tracking direction of the magnetic recording head is improved. In case of the magnetic disk, the tracking direction of the magnetic recording head is a circumferential direction. Therefore, use may be made of a texture having a circumferential regularity, a cross texture having a shape component intersecting therewith, an elliptical texture, a spiral texture, or a combination of these shape components. Among others, the circumferential texture is preferable because of an excellent effect of aligning the magnetic grains in the tracking direction of the magnetic recording head.

In this invention, upon forming the texture by the use of the tape, it is preferable to use a single-substrate tape texturing method. In the single-substrate tape texturing method, a textile or fabric tape such as plastic fiber is pressed against the principal surface of the glass disk and is moved. In this manner, for example, a circumferential texture is formed on the principal surface of the glass disk. At this time, by supplying a polishing liquid containing abrasive grains, such as diamond abrasive grains, high in hardness as compared with the glass, a fine texture can be formed on the principal surface of the glass disk.

### BRIEF DESCRIPTION OF THE DRAWING

A sole FIGURE is a schematic cross-sectional view showing a layer structure of a magnetic disk according to an embodiment of this invention.

### DESCRIPTION OF THE PREFERRED EMBODIMENT

Hereinafter, an embodiment of this invention will be explained in more detail in conjunction with examples. It is noted here that this invention is not restricted to the following examples.

### EXAMPLE 1

In this example, the glass substrate for a magnetic disk was manufactured through (1) a rough lapping step (rough grinding step), (2) a shaping step, (3) a fine lapping step (fine grinding step), (4) an end-face mirror-polishing step, (5) a first polishing step, (6) a second polishing step (principal surface mirror-polishing step), (7) a chemically strengthening step, (8) a chemical treatment step, (9) a texturing step, and (10) a precision cleaning step. Hereinafter, each step will be described.

(1) Rough Lapping Step

At first, a molten glass was subjected to direct pressing by the use of an upper mold, a lower mold, and a body mold to obtain a disk-shaped glass disk made of an aluminosilicate glass and having a diameter of 66 mmφ and a thickness of 1.5 mm. Instead of the direct pressing, the disk-shaped glass disk may be obtained by forming a sheet glass by a down drawing method or a floating method and then cutting the sheet glass by a grindstone. As the aluminosilicate glass, use was made of an aluminosilicate glass consisting of 63.6 weight % SiO₂, 14.2 weight % Al₂O₃, 10.4 weight % Na₂O, 5.4 weight % Li₂O, 6.0 weight % ZrO₂, and 0.4 weight % Sb₂O₃.

Subsequently, the glass disk was subjected to a lapping step in order to improve dimensional accuracy and shape accuracy. The lapping step was carried out by the use of a double-sided lapping apparatus with abrasive grains having a grain size of #400. Specifically, at first, alumina abrasive grains having a grain size of #400 were used and a load was set to about 100 kg. Then, by rotating a sun gear and an internal gear of the above-mentioned lapping apparatus, opposite surfaces of the glass disk received in a carrier were lapped to a surface accuracy of 0-1 μm and a surface roughness (Rmax) of about 6 μm.

(2) Shaping Step

Next, by the use of a cylindrical grindstone, the glass disk was bored at its center. In addition, an outer peripheral end face was ground so that the diameter of the glass disk is equal to 65 mmφ. Thereafter, the glass disk was chamfered at its outer and inner peripheral end faces. At this time, the end faces of the glass disk had a surface roughness of about 4 μm in Rmax. Generally, a magnetic disk having an outer diameter of 65 mm is used in a 2.5-inch HDD (Hard Disk Drive).

(3) Fine Lapping Step

Next, by the use of abrasive grains having a grain size of #1000, the surfaces of the glass disk were lapped to the surface roughness of about 2 μm in Rmax and about 0.2 cm in Ra. After the lapping step, the glass disk was subjected to ultrasonic cleaning by successively immersing the glass disk in cleaning tanks respectively filled with a neutral detergent and water (applied with an ultrasonic wave).

(4) End-face Mirror-Polishing Step

Subsequently, the glass disk was rotated and the end faces (inner and the outer peripheral) of the glass disk were polished to the surface roughness of about 1 μm in Rmax and about 0.3 μm in Ra by brush-polishing. Then, the surfaces of the glass disk after subjected to the above-mentioned end-face mirror-polishing step were cleaned with water.

(5) First Polishing Step

Next, in order to remove a flaw and distortion remaining after the above-mentioned lapping step, a first polishing step was carried out by the use of a double-sided polishing apparatus. In the double-sided polishing apparatus, the glass disk held by a carrier was inserted between upper and lower surface tables with polishing pads attached hereto and brought into contact therewith. The carrier is engaged with a sun gear and an internal gear. The glass disk is clamped and pressed by the upper and the lower surface tables. Thereafter, a polishing liquid is supplied between each of the polishing pads and each of polished surfaces of the glass disk while the carrier is rotated. Thus, the glass disk is rotated and revolved on the surface tables so that the opposite surfaces are simultaneously polished. Hereinafter, the same double-sided polishing apparatus was used in common to all examples. More specifically, the polishing step was carried out by using a hard polisher (hard urethane foam) as a polisher. The polishing condition was as follows. As a polishing liquid, ultra pure water with cerium oxide (average grain size: 1.3 cm) dispersed therein as an abrasive was used. The load was set to 100 g/cm², and the polishing time was set to 15 minutes. After the first polishing step, the glass substrate was successively dipped into cleaning tanks respectively filled with a neutral detergent, pure water, pure water, IPA (isopropyl alcohol), and IPA (vapor dry) to be subjected to ultrasonic cleaning and dried.

(6) Second Polishing Step (Principal Surface Mirror-Polishing Step)

Next, by the use of a double-sided polishing apparatus of the type same as that used in the first polishing step, the second polishing step was carried out by the use of a soft pad polisher (suede pad) instead of the above-mentioned polisher. The second polishing step was intended to reduce the surface roughness, for example, to about 1.0-0.3 μm or less in Ra while maintaining a flat surface obtained in the first polishing step. By this second polishing step, the principal surface of the glass disk was finished to a mirror surface. The polishing condition was as follows As a polishing liquid, ultra pure water with cerium oxide (average grain size: 0.8 μm) dispersed therein was used. The load was set to 100 g/cm², and the polishing time was set to 5 minutes. After the second polishing step, the glass disk was successively dipped into cleaning tanks respectively filled with a neutral detergent, pure water, pure water, IPA, and IPA (vapor dry) to be subjected to ultrasonic cleaning and dried.

(7) Chemically Strengthening Step

Next, the glass disk after cleaned was subjected to a chemically strengthening step by low-temperature ion exchange in the following condition. Specifically, a chemically strengthening molten salt was prepared by mixing potassium nitrate (60%) and sodium nitrate (40%). The chemically strengthening molten salt was heated to 380° C. The glass disk after cleaned and dried was dipped into the chemically strengthening molten salt for 240 minutes. Thus, the glass disk was chemically strengthened.

Subsequently, the glass disk after the chemically strengthening step was subjected to visual inspection of its surface and close inspection utilizing reflection, scattering, and transmission of light. As a result, any protrusion by deposited substances or any defect such as a flaw was not found on the surface of the glass disk. Furthermore, the surface roughness of a principal surface of the glass disk obtained via the above-mentioned steps was measured by an atomic force microscope (AFM). As a result, the glass disk with an ultrasmooth mirror surface having Rmax of 2.13 nm and Ra of 0.20 nm was obtained. Both of Rmax and Ra are specified by Japanese Industrial Standard (JIS) B0601. The glass disk thus obtained had an outer diameter of 65 mm, an inner diameter of 20 mm, and a thickness of 0.635 mm.

(8) Chemical Treatment Step

Next, the obtained glass disk was subjected to a chemical treatment step by using alkali. As an alkali solution, a solution containing NaOH of 0.1 weight % was used. By the use of a PH meter, PH of the solution was measured and was equal to 13. The temperature of the solution was kept at 50° C., and the above-mentioned glass disk was dipped therein for 180 minutes. In order to achieve a cleaning effect of the glass disk, an ultrasonic wave was applied during the treatment.

The shape surface of the principal surface of the glass disk after the chemical treatment step was measured by the AFM. As a result, it was found out that the smooth mirror surface having Rmax of 4.66 nm and Ra of 0.30 was obtained. Herein, a measuring region was 5 μm×5 μm. By this chemical treatment step, the principal surface of the glass disk was etched (removed) by a thickness of 0.1 nm.

(9) Texturing Step

By the use of a tape-type texturing apparatus, a polishing and circumferential texturing process was carried out. In this event, as a tape, a textile tape was used. As a hard polisher, use was made of a slurry comprising polycrystalline diamond having an average grain size of 0.125 μm and suspended in a dispersing agent and a lubricating agent (glycerin).

In this case, the texturing condition was as follows:
Processing Load: 1.4 kg
Processing Pressure: 12 g/mm²
Rotation Speed of Substrate: 1000 rpm
Tape Feeding Rate: 2 mm/sec
Texturing Time: 30 sec

After the texturing step, preliminary cleaning was carried out by ultra pure water shower for 5 minutes in order to wash away the diamond slurry and the dispersing agent (lubricating agent) of the aforementioned polisher.

(10) Precision Cleaning Step

Subsequently, the glass disk provided with the texture was subjected to precision cleaning. This precision cleaning was performed in order to remove the residue of the polisher, iron-based contamination of an external origin, and the like, causing head crash or a thermal asperity defect and to obtain a glass substrate having a smooth and clean surface. This precision cleaning step comprises a series of cleaning steps as follows.

At first, a cleaning step using a cleaning liquid was carried out. The cleaning liquid was prepared by mixing KOH and NaOH at a ratio of 1:1 to obtain a chemical liquid, diluting the chemical liquid with ultra pure water, and adding a nonionic surface active agent in order to improve a cleaning ability. PH of the cleaning liquid was adjusted to 12.4 by dilution with the ultra pure water. The glass disk was cleaned for two minutes by rocking the glass disk dipped in the cleaning liquid. In this event, the temperature of the cleaning liquid was kept at 50° C., and the ultrasonic wave was applied so as to improve the cleaning effect.

Then, a water rinse cleaning step was carried out for two minutes. This step was performed in order to remove the residue of the cleaning liquid used in the above-mentioned cleaning.

Subsequently, an IPA cleaning step was carried out for two minutes. This step was performed in order to clean the glass disk and to remove water on the substrate.

Finally, an IPA vapor drying step was carried out for two minutes. The step was performed in order to remove liquid IPA adhered to the substrate by IPA vapor and to dry the substrate.

Next, the glass substrate obtained after the precision cleaning step was subjected to visual inspection of its surface and close inspection utilizing reflection, scattering, and transmission of light. As a result, any protrusion by deposited substances or any defect such as a flaw was not found on the surface of the glass substrate. Further, any contaminants causing head crush or a thermal asperity defect were not observed also.

Then, the shape of the principal surface of the glass substrate obtained via the above-mentioned steps was measured. The surface shape was measured by the AFM (atomic force microscope) in a tapping mode in which evaluation can be carried out at high resolution. A measuring range was 1 μm×1 μm on the principal surface of the glass substrate. A cantilever (probe) used upon measurement by AFM had a tip radius of curvature of 10 nm in order to obtain a measuring result at high accuracy. Use was made of a sampling mode in which 256×256 zones were sampled. The wavelength band of the measured shape was 3.9 nm to 1000 nm. As a result, a uniform circumferential texture was formed on the surface of the glass substrate for a magnetic disk in this example. Rmax and Ra were 8.25 nm and 0.69 nm in the radial direction, respectively. The ratio Ra(r)/Ra(c) of the surface roughness Ra(r) in the radial direction with respect to the surface roughness Ra(c) in the circumferential direction was equal to 4.68 as shown in Table 1. Herein, a greater value of Ra(r)/Ra(c) indicates that a more uniform texture is formed. Generally, in order to obtain the uniform texture shape required for achieving high anisotropy, the value of Ra(r)/Ra(c) must be equal to 3 or more. When the value of Ra(r)/Ra(c) is smaller than 3, the texture shape is non-uniform so that the magnetic anisotropy can be hardly obtained.

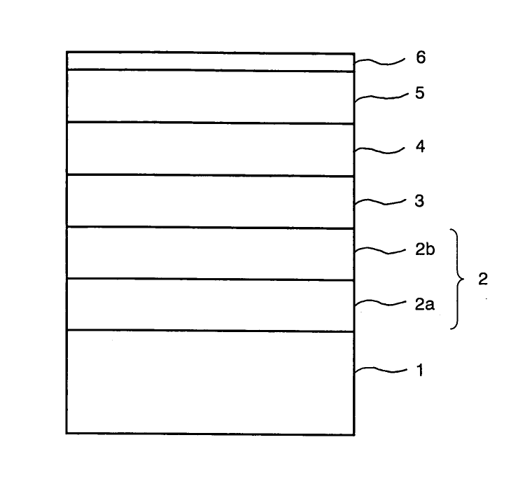

By the use of a single-substrate sputtering apparatus, the seed layer 2, the underlayer 3, the magnetic layer 4, the protection layer 5, and the lubrication layer 6 were successively formed on the glass substrate for a magnetic disk obtained as mentioned above. Thus, the magnetic disk having the structure illustrated in FIG. 1 was obtained.

As the seed layer 2, a first seed layer 2a comprising a Cr alloy thin film (having a thickness of 600 angstroms) and a second seed layer 2b comprising an AlRu thin film (having a thickness of 300 angstroms) were formed. It is noted here that the AlRu thin film has a composition of 50 at % Al and 50 at % Ru.

As the underlayer 3, a CrW thin film (having a thickness of 100 angstroms) was formed so as to achieve an excellent crystal structure of the magnetic layer. The CrW thin film has a composition of 90 at % Cr and 10 at % W. In order to promote miniaturization of crystal grains, deposition was carried out in a mixed gas atmosphere containing an Ar gas and a CO₂ gas. In this event, the ratio of the CO₂ gas with respect to the Ar gas was equal to 0.75%.

The magnetic layer 4 comprises a CoCrPtB alloy and has a thickness of 150 angstroms. The contents of Co, Cr, Pt, and B of the magnetic layer were 62 at % Co, 20 at % Cr, 12 at % Pt, and 6 at % B.

The protection layer 5 serves to prevent the magnetic layer 4 from being deteriorated by contact with a magnetic head, and comprises hydrogenated carbon having a thickness of 50 angstroms. The lubrication layer 6 was formed by applying a perfluoropolyether liquid lubricant by dipping method, and had a thickness of 9 angstroms.

Subsequently, magnetic characteristics and reliability of the magnetic disk thus obtained was evaluated in the following manner.

(Evaluation of Magnetic Characteristics)

Magnetic characteristics were measured by VSM (Vibrating Sample Magnetometry). From the magnetic disk, a circular sample having a diameter of 8 mm was cut around a position of 32 mm in radius as a center. The sample was applied with an external magnetic field (±10 kOe) in each of a circumferential direction and a radial direction of the substrate to obtain a magnetization curve. From the magnetization curve, Mrt (product of residual magnetization and film thickness) in each of the circumferential direction and the radial direction of the substrate was calculated.

The result is shown in Table 1. In this example, MrtOR of 1.30 could be obtained.

(Evaluation of Reliability)

The magnetic disk thus obtained was evaluated for glide characteristics. As a result, the touch down height was equal to 4.2 nm. The touch down height is obtained by gradually decreasing the flying height of the flying head (for example, by lowering the rotation speed of the magnetic disk) and detecting the flying height when the head starts contacting with the magnetic disk. Thus, the ability of the flying height of the magnetic disk is measured. Generally, the HDD required to have a recording density not lower than 40 Gbit/inch² must have a touch down height not higher than 5 nm.

Further, a LUL durability test was carried out by repeating load/unload operations of the head at 70° C. and under 80% RH environment, with the flying height of the flying head set to 12 nm. As a result, even after the 600,000 times of LUL operations, any trouble such as head crash or thermal asperity was not caused. In the HDD generally used, about 10 years use is required before the number of times of LUL operations exceeds 600,000. In this example, therefore, the magnetic disk high in reliability and durability could be obtained.

### EXAMPLES 2 and 3

In (8) chemical treatment step of Example 1, the NaOH solution was replaced by a 0.1 weight % potassium hydroxide (KOH) solution and the treatment was carried out at 50° C. for 180 seconds. The KOH solution used as the chemical liquid had PH of 12.6 (Example 2).

Further, in (8) chemical treatment step of Example 1, the NaOH solution was replaced by a 0.06 weight % ammonium fluoride solution and the treatment was carried out at 50° C. for 180 seconds. The ammonium fluoride solution used as the chemical liquid had PH of 2 to 3 (Example 3).

In both Example 2 and Example 3, the glass substrate for a magnetic disk and the magnetic disk were manufactured in the manner similar to Example 1 except that the different chemical liquid was used. Then, evaluation was carried out in the manner similar to Example 1. The results are shown in Table 1.

### COMPARATIVE EXAMPLE

In (8) chemical treatment step of Example 1, the NaOH solution was replaced by pure water, and the treatment was carried out at 50° C. for 180 seconds.

The glass substrate for a magnetic disk and the magnetic disk were manufactured in the manner similar to Example 1 except that the chemical treatment using the chemical liquid was not carried out. Further, evaluation was carried out in the manner similar to Example 1 The results are shown in Table 1.

TABLE 1

| | | | Surface | | | |
|---|---|---|---|---|---|---|
| | | | profile after | | | |
| | chemical | | chemical | surface profile after | | |
| | treatment | | treatment | texturing (AFM) | | magnetic |
| | | Concentration | (AFM) | Ra(r) | | anisotropy |
| | material | [wt %] | Ra [nm] | [nm] | Ra(r)/Ra(c) | MrtOR |
| Example 1 | NaOH | 0.10 | 0.30 | 0.69 | 4.68 | 1.30 |
| Example 2 | KOH | 0.10 | 0.36 | 0.56 | 3.69 | 1.25 |
| Example 3 | NH₄F | 0.06 | 0.40 | 0.67 | 4.49 | 1.31 |

| | | | | | |
|---|---|---|---|---|---|
| Comparative | not carried out | 0.48 | 0.55 | 2.85 | 1.10 |
| Example | (pure water only) | | | | |

From the results shown in Table 1, it is found out that, by carrying out the chemical treatment step using the chemical liquid before the texturing step, the uniform texture shape can be obtained and the magnetic disk having excellent magnetic anisotropy given by MrtOR not lower than 1.2 can be obtained.

On the other hand, in Comparative Example in which the chemical treatment step is not performed, it is assumed that variation of residual stress caused by the mirror-polishing is left on the principal surface of the glass disk. Therefore, the shape of the texture is non-uniform and the magnetic anisotropy is hardly obtained, as seen from the table.

As explained above, according to this invention, even when the glass substrate is used as the substrate for a magnetic disk, it is possible to obtain the uniform texture shape and to provide the glass substrate for a magnetic disk, which is capable of inducing the high magnetic anisotropy in the magnetic layer. Further, since the high magnetic anisotropy is obtained even when the glass substrate is used as described above, it is possible to provide the magnetic disk which is capable of achieving the high recording density, excellent in shock resistance, and low in cost.

Moreover, this invention is suitable in case where use is made of the aluminosilicate glass substrate in which unevenness of the residual stress caused by the mirror-polishing is readily formed on the principal surface of the substrate. In addition, this invention is suitable in case where use is made of the glass substrate chemically strengthened and excellent in shock resistance.

1. A method of manufacturing a glass substrate for a magnetic disk, in which a texture is formed by a tape on a principal surface of a mirror-polished glass disk, wherein:
the glass substrate is subjected to a chemical treatment before forming the texture so as to remove at least a part of a polishing-affected layer which is formed on the principal surface of the glass disk.

2. A method of manufacturing a glass substrate for a magnetic disk as claimed in claim 1, wherein the chemical treatment is carried out by the use of at least one material selected from sodium hydroxide, potassium hydroxide, and ammonium fluoride.

3. A method of manufacturing a glass substrate for a magnetic disk as claimed in claim 1, wherein the mirror-polished glass disk is chemically strengthened after mirror-polishing.

4. A method of manufacturing a glass substrate for a magnetic disk as claimed in claim 1, wherein the glass disk essentially consists of 58-75 weight % SiO₂, 5-23 weight % Al₂O₃, 3-10 weight % Li₂0, and 4-13 weight % Na₂

5. A method of manufacturing a magnetic disk, wherein at least a magnetic layer is formed on the glass substrate manufactured by the method claimed in claim 1.
